(19) United States
(12) Patent Application Publication
(10) Pub. No.: US 2014/0361452 A1
(43) Pub. Date: Dec. 11, 2014

(54) METHOD AND APPARATUS FOR MAKING A TAPER IN AN OPTICAL FIBER

(71) Applicant: AFL Telecommunications LLC, Duncan, SC (US)

(72) Inventor: Wenxin Zheng, Ellicott City, MD (US)

(73) Assignee: AFL Telecommunications LLC, Duncan, SC (US)

(21) Appl. No.: 14/373,066

(22) PCT Filed: Jan. 22, 2013
(86) PCT No.: PCT/US13/22448

§ 371 Date: Jul. 18, 2014

Related U.S. Application Data
(60) Provisional application No. 61/588,898, filed on Jan. 20, 2012.
(60) Provisional application No. 61/589,527, filed on Jan. 23, 2012.

(51) Int. Cl. B29D 11/00

(52) U.S. Cl. CPC B29D 11/00721; B29L 2011/0075
USPC 264/1.24; 425/383

(57) ABSTRACT

A method of making a taper in an optical fiber including: securing the optical fiber in a first holder and a second holder, heating the optical fiber, and moving the first holder in a first direction with a pulling speed and at the same time moving the second holder in the first direction with a feeding speed, wherein a ratio of the pulling speed to the feeding speed is greater than one.

### CROSS-REFERENCE TO RELATED APPLICATIONS

This application is based upon and claims the benefit of priority from U.S. Provisional Application Nos. 61/588,898, filed Jan. 20, 2012, and 61/589,527, filed Jan. 23, 2012, in the United States Patent and Trademark Office, the disclosures of which are incorporated herein in its entirety by reference.

### BACKGROUND

1. Field

The invention is related to a method and apparatus for making a taper in an optical fiber, and more particularly to a method and apparatus for making an adiabatic taper in an optical fiber.

2. Related Art

An adiabatic taper in an optical fiber is a taper that has very low power leakage. To achieve an adiabatic taper, the fiber diameter variation must be very smooth and well controlled. The adiabatic angle, θ, is a threshold taper angle which defines the largest taper angle for acceptable taper loss. See FIG. 1. Different fiber designs have different adiabatic taper angles. For single mode fibers, the adiabatic angle θ is approximately 0.35 degrees. For other fiber types, this angle is typically determined by experiment.

Adiabatic tapers may be used in several components for fiber lasers. For example, they can be used in a tapered fused bundle combiner, a mode field adapter, in splices and in an end cap. They can also be used for adiabatic taper high order mode (HOM) filters and refractive index sensors.

In a conventional method for making adiabatic tapers, tension and heat are applied to a portion of an optical fiber. The heat is normally provided by a heat element such as flame, furnace, arc discharge, or filament. The heat element moves back and forth and travels at a predetermined rate along the elongated length of the optical fiber while applying a tension to the optical fiber with fiber holders on each side of the elongated region traveling in opposite directions (see for example, U.S. patent application No. 2008/0022726 A1). The heating strength and width can also be well controlled at different location of the fiber to form a required shape of taper (see for example, FIG. 3 in U.S. Pat. No. 6,466,717).

A major disadvantage of these methods is the moving heating element. It creates a lot of complexity in machine design and operation. Some types of heating elements are relatively small and thus easier to move, such as torches and filaments. But some of heating systems are not very easy to move, such as furnaces and CO₂ lasers.

It is an object of the invention to provide a method and system which can make an optical fiber taper with desired shape, either adiabatic or non-adiabatic, depending on applications, with a stationary heating element.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

An embodiment of the invention is a method of making a taper in an optical fiber including securing the optical fiber in a first holder and a second holder, heating the optical fiber, and moving the first holder in a first direction with a pulling speed and at the same time moving the second holder in the first direction with a feeding speed, wherein a ratio of the pulling speed to the feeding speed is greater than one.

Other features of this embodiment include: during a first time period, the ratio increases and increases at a parabolic rate. Also, for a second time period, the ratio decreases and decreases at a parabolic rate. Also, for a third time period, the ratio is constant.

Other features include the taper being an adiabatic taper and a taper being an angle of less than approximately 0.35 degrees.

Another embodiment of the invention is a method of making a taper in an optical fiber including securing said optical fiber in a first holder and a second holder, heating the optical fiber, moving the first holder in a first direction with a pulling speed and at the same time moving the second holder in the first direction with a feeding speed, wherein a ratio of the pulling speed to the feeding speed is less than one.

Other features of this embodiment include: during a first time period, the ratio decreases and decreases at a parabolic rate. Also, for a second time period, the ratio is constant. Also, for a third time period, the ratio increases.

Another embodiment of the invention is an apparatus for making a taper in an optical fiber including: a first holder and a second holder for securing the optical fiber, a heat source for heating the optical fiber, a first motor for moving the first holder, a second motor for moving the second holder, and a processor configured to move the first holder in a first direction with a pulling speed and at the same time move the second holder in the first direction with a feeding speed, wherein a ratio of the pulling speed to the feeding speed is greater than one.

Other features of this embodiment include: during a first time period, the ratio increases and increases at a parabolic rate. Also, for a second time period, the ratio decreases and decreases at a parabolic rate. Also, for a third time period, the ratio is constant.

Other features include the taper being an adiabatic taper and a taper being an angle of less than approximately 0.35 degrees.

Another embodiment of the invention is an apparatus for making a taper in an optical fiber including a first holder and a second holder for securing the optical fiber, a heat source for heating the optical fiber, a first motor for moving the first holder, a second motor for moving the second holder, and a processor configured to move the first holder in a first direction with a pulling speed and at the same time move the second holder in the first direction with a feeding speed, wherein a ratio of the pulling speed to the feeding speed is less than one.

Other features of this embodiment include: during a first time period, the ratio decreases and decreases at a parabolic rate. Also, for a second time period, the ratio is constant. Also, for a third time period, the ratio increases.

### BRIEF DESCRIPTION OF THE DRAWING

FIG. 1 shows an adiabatic tapered optical fiber.

FIG. 2 shows an exemplary embodiment of an optical fiber tapering apparatus of the present invention.

FIG. 3 shows an example of a taper being created in an optical fiber and parameters for creating tapers and an end cap.

FIGS. 4 and 5 show exemplary algorithms for creating a taper in an optical fiber.

FIG. 6 shows a PC interface for making and measuring a taper.

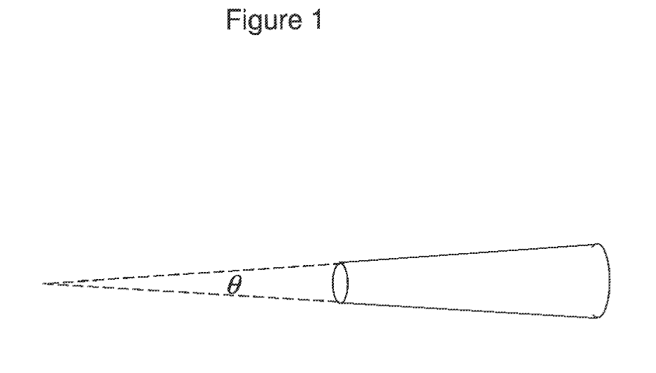

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

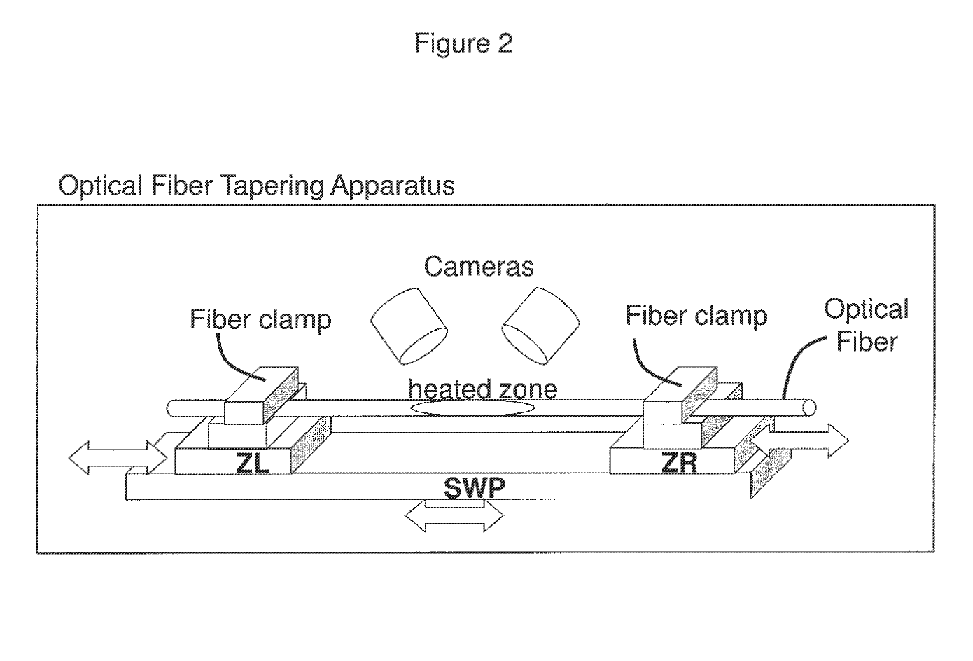

FIG. 2 is an exemplary embodiment of an optical fiber tapering apparatus of the present invention. The apparatus could be provided as part of an optical fiber splicer, such as the AFL FSM100. The apparatus includes structures to secure the optical fiber to be tapered, such as fiber clamps. The fiber clamps can be mounted on motorized structures ZL (left) and ZR (right), which can move left and right, independent of each other, when looking at the figure. The motorized structures ZL and ZR can also be mounted on a motorized sweep platform SWP, which can also move left and right, when looking at the figure. The motorized structures ZL and ZR can be configured so that they move in unison with the motorized sweep platform SWP, or independent of the platform.

The apparatus is able to create a heated zone on the optical fiber. The heat can be provided by, among other items, a CO₂ laser, arc discharge, filament or flame (not shown). The heat source can remain stationary because the fiber moves during the tapering process. The apparatus may also include cameras, which can observe the tapering process so that adjustments may be made in order to obtain the desired taper.

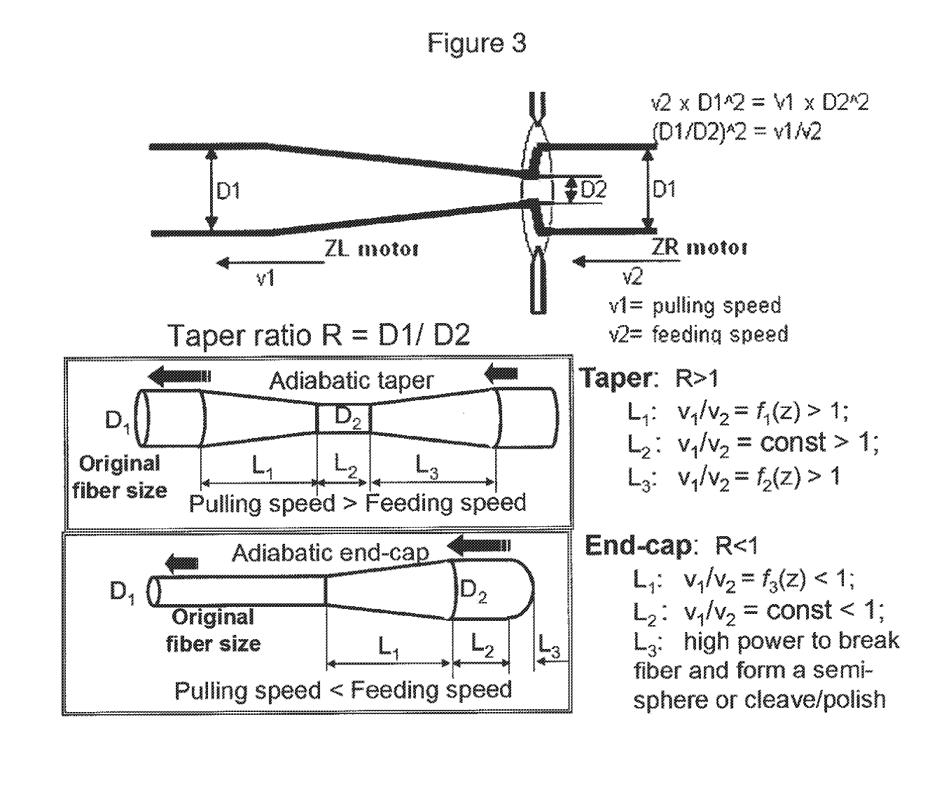

FIG. 3 shows an example of a taper being created in an optical fiber and an example of the general conditions for creating tapers and an end cap. First, the conditions for creating an adiabatic taper will be described and second, the conditions for creating an adiabatic end cap will be described. In both examples, v₁ is the pulling speed, v₂ is the feeding speed, D₁ is the diameter of the original optical fiber, D₂ is the diameter of the optical fiber after tapering (D₂ can be larger or smaller than D₁).

With respect to the adiabatic taper shown in FIG. 3 with D₁/D₂ greater than 1, the following conditions must be met. To create the portion marked as L₁, the ratio of v₁/v₂ is a function f₁(z) that is greater than one. This means that for a time period the optical fiber is being pulled faster than it is being fed. In order to get a downward taper, f₁(z) must be an increasing function. Downward means that the diameter gets smaller and smaller during the tapering process. In a preferred embodiment, the pulling speed increases at a parabolic rate.

To create the portion marked as L₂, which is a portion without a taper, the ratio of v₁/v₂ is a constant that is greater than one for a time period.

To create the portion marked as L₃, the ratio of v₁/v₂ is a function f₂(z) that is greater than 1. This means that the optical fiber is being pulled faster than it is being fed for a time period. In order to get a upward taper, f₂(z) must be a decreasing function. Upward means the diameter gets larger and larger during the tapering process. In a preferred embodiment, the pulling speed decreases at a parabolic rate.

With respect to the adiabatic end cap shown in FIG. 3 with D₁/D₂ less than one, the following conditions must be met. To create the portion marked as L₁, the ratio of v₁/v₂ is a function f₃(z) that is less than one. This means that the optical fiber is being fed faster than it is being pulled for a time period. In order to get a upward taper, f₃(z) must be an decreasing function. In a preferred embodiment, the pulling speed decreases at a parabolic rate.

To create the portion marked as L₂, which is a portion without a taper, the ratio of v₁/v₂ is a constant that is less than one for a time period.

To create the portion marked as L₃, the ratio of v₁/v₂ is a function that is greater than one. This means that the optical fiber is being pulled more than it is being fed for a time period. The power of the heat source is then increased such that the fiber is broken and a semi-sphere or cleave/polish is created.

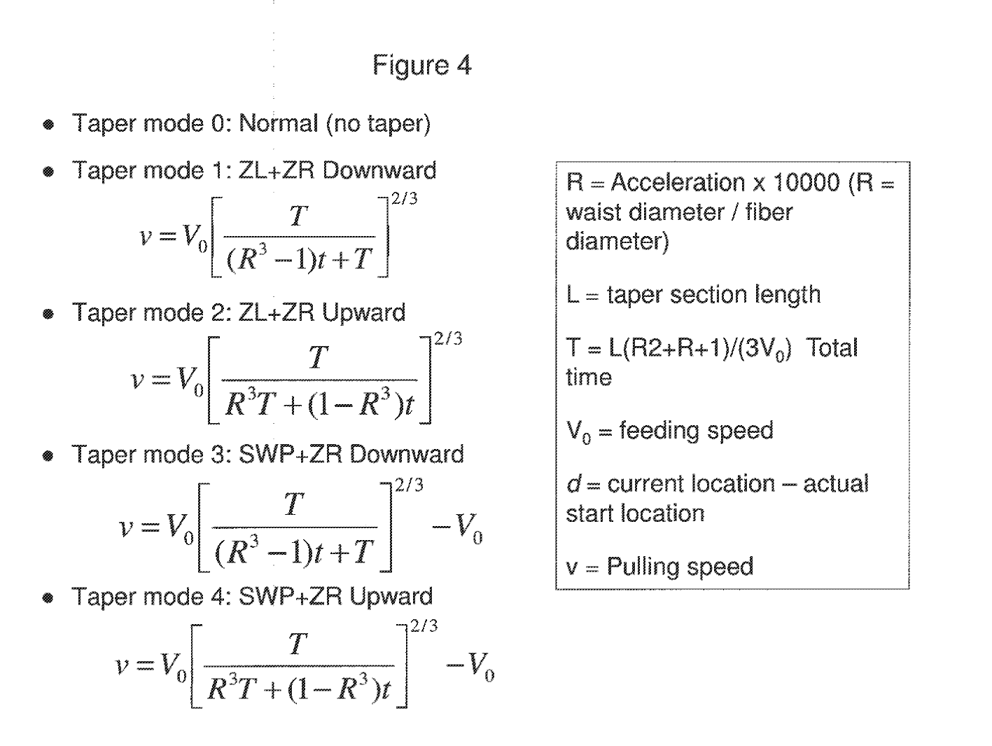

FIG. 4 shows examples of some tapering mode algorithms that can be programmed into a computer or processor to control the motors in the optical fiber tapering apparatus to create tapers in an optical fiber. The program can be stored on a computer readable medium in the apparatus, or external to the apparatus. In these algorithms, time is the control variable. In taper mode 0, the speed of the motors is equal and constant. In this mode, a taper is not created. Taper mode 1 shows an algorithm for creating a downward taper, such as the L₁ portion in the adiabatic taper example in FIG. 3. Taper mode 2 shows an algorithm for creating an upward taper, such as the L₃ portion in the adiabatic taper example in FIG. 3. In taper modes 1 and 2, motorized structures ZL and ZR move independently of the sweep platform SWP and the sweep platform SWP remains stationary.

Taper mode 3 shows an algorithm for creating a downward taper, such as the L₁ portion in the adiabatic taper example in FIG. 3. Taper mode 4 shows an algorithm for creating an upward taper, such as the L₃ portion in the adiabatic taper example in FIG. 3. In taper modes 3 and 4, motorized structures ZR move independently of the sweep platform SWP, and motorized structure ZL moves with sweep platform SWP.

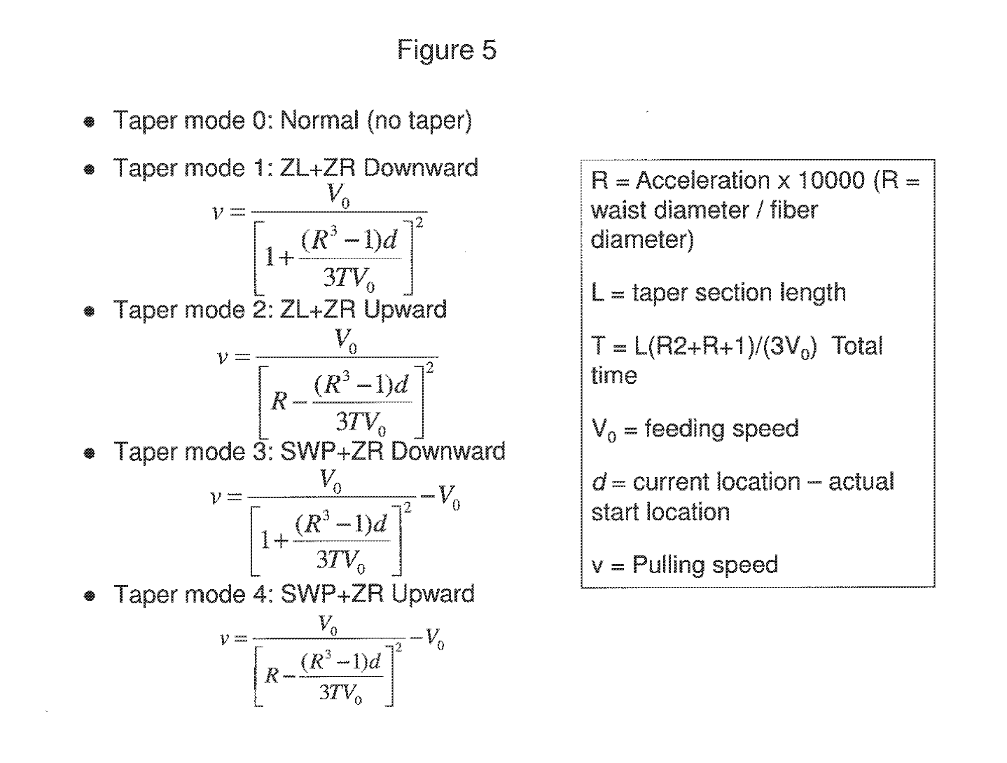

FIG. 5 shows other examples of some tapering mode algorithms that can be programmed into a computer or processor to control the motors in the optical fiber tapering apparatus to create tapers in an optical fiber. In these algorithms, distance is the control variable. Taper modes 0 through 4 are the same as in FIG. 4, except that distance is the control parameter.

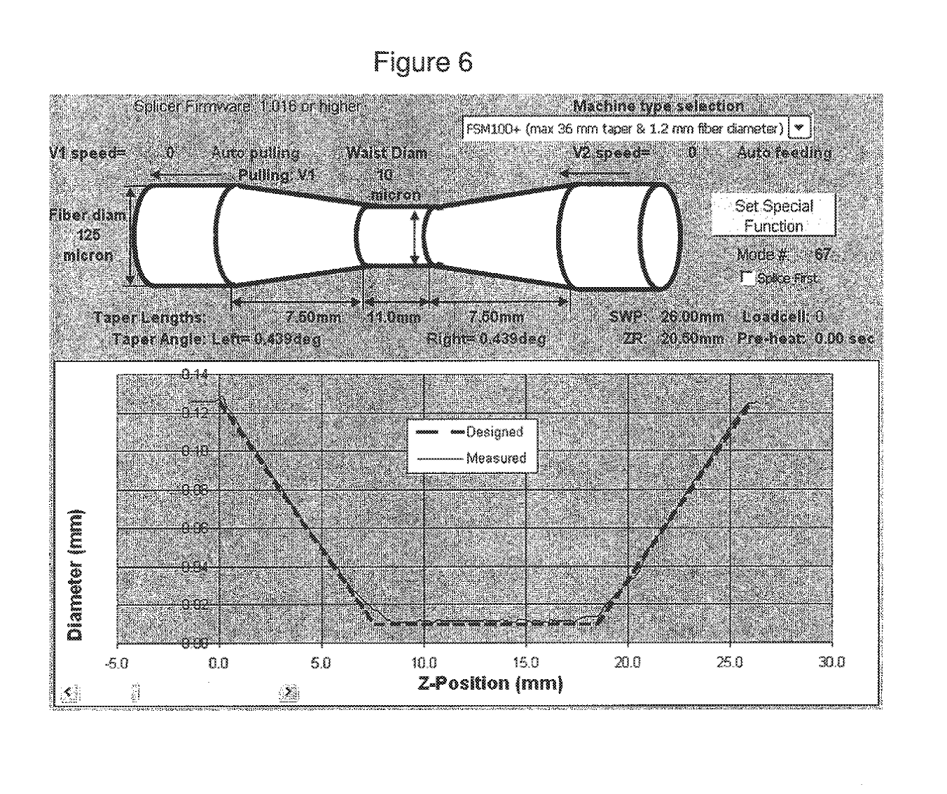

FIG. 6 shows one example of a fiber with 125 μm cladding diameter which is tapered down to 10 μm with 11 mm long waist and 7.5 mm long upward taper and downward taper regions. In the chart, the dashed curve is the designed curve and the solid curve is an actual measured curve to the taper. The agreement between the designed curve and the measured curve are almost on top of each other. The taper ripple is less than 3 μm.

Some of the key features and advantages of the invention are discussed below. First, the tapering is performed with motors moving at the same direction, one for pulling the optical fiber and one for feeding the optical fiber. Also, the tapering process can be performed with or without applying tension to the optical fiber. The pulling and feed speeds can be computed in real-time by a computer or processor. The method also allow for the use of use a fixed pulling speed for high speed, or a fixed feeding speed for high accuracy.

The method makes it possible to create a normal taper (waist diameter less fiber diameter) or inversed taper (waist diameter greater than fiber diameter). The taper can be made on a fiber with constant diameter along its axis or with a variable diameter using a camera to monitor the fiber size during tapering. The taper process can fully controlled step-motors for consistency for factory applications.

With this process, the heating element (source) is kept stationary and does not need to move during tapering. This is a big advantage if the heating source is large and not easy to move, such as a CO₂ laser. With a stationary heating source, the camera does not need to move and it is easy to monitoring the process in real-time. Because the camera is stationary, image quality can remain high.

As mentioned above, although the exemplary embodiments described above are various methods for creating tapers in an optical fiber, they are merely exemplary and the general inventive concept should not be limited thereto, and it could also apply to other types of tapers or shapes of fibers.

What is claimed:

1. A method of making a taper in an optical fiber comprising:
securing said optical fiber in a first holder and a second holder;
heating said optical fiber; and
moving said first holder in a first direction with a pulling speed and at the same time moving said second holder in said first direction with a feeding speed;
wherein a ratio of said pulling speed to said feeding speed is greater than one.

2. The method of claim 1, wherein for a first time period, said ratio increases.

3. The method of claim 2, wherein said ratio increases at a parabolic rate.

4. The method of claim 2, wherein for a second time period, said ratio decreases.

5. The method of claim 4, wherein said ratio decreases at a parabolic rate.

6. The method of claim 2, wherein for a third time period, said ratio is constant.

7. The method of claim 4, wherein for a third time period, said ratio is constant.

8. The method of claim 1 wherein said taper has an angle of less than approximately 0.35 degrees.

9. The method of claim 1 wherein said taper is an adiabatic taper.

10. A method of making a taper in an optical fiber comprising:
securing said optical fiber in a first holder and a second holder;
heating said optical fiber;
moving said first holder in a first direction with a pulling speed and at the same time moving said second holder in said first direction with a feeding speed;
wherein a ratio of said pulling speed to said feeding speed is less than one.

11. The method of claim 10, wherein for a first time period, said ratio decreases.

12. The method of claim 11, wherein said ratio decreases at a parabolic rate.

13. The method of claim 11, wherein for a second time period, said ratio is constant.

14. The method of claim 10, wherein for a third time period, said ratio increases.

15. An apparatus for making a taper in an optical fiber comprising:
a first holder and a second holder for securing said optical fiber;
a heat source for heating said optical fiber;
a first motor for moving said first holder;
a second motor for moving said second holder; and
a processor configured to move said first holder in a first direction with a pulling speed and at the same time move said second holder in said first direction with a feeding speed;
wherein a ratio of said pulling speed to said feeding speed is greater than one.

16. The apparatus of claim 15, wherein for a first time period, said ratio increases.

17. The apparatus of claim 16, wherein said ratio increases at a parabolic rate.

18. The apparatus of claim 16, wherein for a second time period, said ratio decreases.

19. The apparatus of claim 18, wherein said ratio decreases at a parabolic rate.

20. The apparatus of claim 16, wherein for a third time period, said ratio is constant.

21. The apparatus of claim 18, wherein for a third time period, said ratio is constant.

22. The apparatus of claim 15, wherein said taper has an angle of less than approximately 0.35 degrees.

23. The apparatus of claim 15, wherein said taper is an adiabatic taper.

24. An apparatus for making a taper in an optical fiber comprising:
a first holder and a second holder for securing said optical fiber;
a heat source for heating said optical fiber;
a first motor for moving said first holder;
a second motor for moving said second holder; and
a processor configured to move said first holder in a first direction with a pulling speed and at the same time move said second holder in said first direction with a feeding speed;
wherein a ratio of said pulling speed to said feeding speed is less than one.

25. The apparatus of claim 24, wherein for a first time period, said ratio decreases.

26. The apparatus of claim 25, wherein said ratio decreases at a parabolic rate.

27. The apparatus of claim 25, wherein for a second time period, said ratio is constant.

28. The apparatus of claim 24, wherein for a third time period, said ratio increases.
